(19) United States
(12) Patent Application Publication
(10) Pub. No.: US 2008/0050046 A1
(43) Pub. Date: Feb. 28, 2008

(54) Image Processing System and Method Using Feedback Route

(76) Inventor: Yeong Seok Kim, Suwon-si (KR)

Correspondence Address: F. CHAU & ASSOCIATES, LLC, 130 WOODBURY ROAD, WOODBURY, NY, 11797, US

(21) Appl. No.: 11/742,074

(22) Filed: Apr. 30, 2007

(30) Foreign Application Priority Data
Aug. 23, 2006 (KR) 10-2006-0079983

(51) Int. Cl. G06K 9/60

(52) U.S. Cl. 382/303

(57) ABSTRACT

An image processing system and method using a feedback route for a final output are provided. The image processing system includes a capture unit outputting a first main frame signal and a first sub-frame signal. A main route unit processes the first main frame signal and outputs a main picture to a display device. A sub-route unit processes the first sub-frame signal and outputs a sub-picture to the display device. A frame buffer stores frame signals. The capture unit is connected to an output terminal of the main route unit via the feedback route. A main route for generating the main picture is separated from a sub-route for generating the sub-picture and a final output signal is fed back to the capture unit. A high-definition sub-picture is obtained. The picture quality of the final output signal and a capture can be verified without using additional elements.

### CROSS-REFERENCE TO RELATED PATENT APPLICATIONS

This application claims priority to Korean Patent Application No. 10-2006-0079983, filed on Aug. 23, 2006, in the Korean Intellectual Property Office, the disclosure of which is hereby incorporated by reference in its entirety.

### BACKGROUND OF THE INVENTION

1. Technical Field

The present disclosure relates to an image processing system and method, and more particularly, to an image processing system and method using a feedback route.

2. Discussion of the Related Art

An image processing system is a system that receives an image signal and processes the image signal for display. The image signal includes a frame signal comprising a plurality of pixels. A digital television (DTV) is an example of a device that uses an image processing system. In a DTV, an image signal is transmitted as an analog RF signal from a broadcast station or base station. The image processor of the DTV converts the analog RF signal into a digital signal using an analog-to-digital converter (ADC) and is thereby able to reconstruct the plurality of pixels.

A frame signal may represent a particular resolution of pixels. For example, a standard definition (SD) DTV may use a frame signal having an interlaced resolution of 720×480 pixels (480i). High-definition (HD) DTV may use a frame signal having an interlaced resolution of 1280×720 (720i) or 1920×1080 (1080i).

FIG. 1A illustrates frame signals input into an image processing system. Referring to FIG. 1A, the frame signals are continuously transmitted at predetermined time intervals. An m-th frame signal 1 is transmitted at a time t=n. An (m+1)th frame signal 3 is transmitted at a time t=(n+1). An (m+2)-th frame signal 5 is transmitted at a time t=(n+2). Here, a process of examining the picture quality of each of the frame signals 1, 3, and 5 is referred to as a spatial test. A process of sequentially examining the picture quality of the frame signals 1, 3, and 5 at the times t=n, t=(n+1), and t=(n+2) is referred to as a temporal test.

FIG. 1B illustrates a conventional image processing system. Referring to FIG. 1B, the conventional image processing system includes a capture unit 101, a pre-processor 105, a scaler 110, a post-processor 115, an encoder 120, and a frame buffer 125. The capture unit 101, the pre-processor 105, the scaler 110, and the post-processor 115 are connected to the frame buffer 125 through data buses 135, 140, 145, and 150, respectively.

The capture unit 101 captures an image frame signal corresponding to an input image signal IMGi and outputs a first frame signal FRM1. The first frame signal FRM1 has the same form as a 720×480i frame signal illustrated in FIG. 1A. The capture unit 101 is an initial input terminal and receives various control signals. The control signals control input/output of data and an output time of the data. The control signals include a horizontal sync signal and a vertical sync signal, which are provided for synchronization when an analog signal is converted into a digital signal.

The pre-processor 105 reduces noise in the first frame signal FRM1 and performs interlacing in order to output a second frame signal FRM2.

The scaler 110 adjusts the size of the second frame signal FRM2 to correspond to the size of an output screen (a main screen or a sub-screen) and outputs a third frame signal FRM3. In an output device (e.g., a TV monitor) which displays an image in a picture in picture (PIP) mode, a screen is divided into a main screen and a sub-screen. In the PIP mode, while a full picture (i.e., the main screen) is displayed, a small picture (i.e., the sub-screen) occupying apart of the full picture is simultaneously displayed. Accordingly, when the image corresponds to the main screen, the scaler 110 adjusts the size of the second frame signal FRM2 to correspond to the size of the main screen.

The post processor 115 improves the picture quality of the third frame signal FRM3 and outputs a fourth frame signal FRM4. To improve the picture quality, gamma & dithering or video & graphic mixing may be used. Dithering is used to make a color similar to a desired color by mixing other colors when the desired color cannot be directly displayed. As such, the picture quality of the third frame signal FRM3 is improved to he as clear as is intended.

The encoder 120 encodes the fourth frame signal FRM4 and outputs a final output signal F_OUT. Frame signals in digital form are converted into analog signals using the encoder 120. At this time, the control signals CON-SIG input into the capture unit 101 are also output.

The frame buffer 125 stores frame signals output from the capture unit 101, the pre-processor 105, the scaler 110, and the post-processor 115. To receive the frame signals, the frame buffer 125 is connected to the capture unit 101, the pre-processor 105, the scaler 110, and the post-processor 115 through the data buses 135, 140, 145, and 150, respectively.

Although the plurality of data buses 135, 140, 145, and 150 are connected with the frame buffer 125, only one data bus can access the frame buffer 125 at any one time. Accordingly, while one of the capture unit 101, the pre-processor 105, the scaler 110, and the post-processor 115 is accessing the frame buffer 125, the others cannot access the frame buffer 125. This characteristic influences a bandwidth of a data bus. When another element, e.g., an output capture and test unit 130 is added and a data bus 155 is added, the number of data bus masters accessing the frame buffer 125 increases and the number of rights of access also increases. Accordingly, the bandwidth increases and signal processing is complicated and delayed. Furthermore, a signal that needs to be processed may not be processed. A data bus master is a device which manages any element (101, 105, 110, 115, 120, or 130) and can access to the frame buffer 125 through a data bus. The data bus master accesses the frame buffer 125 and writes data to or reads data from the frame buffer 125.

The first through fourth frame signals FRM1 through FRM4 are stored in the frame buffer 125. The frame buffer 125 verifies the validity of each frame signal. Accordingly, the frame buffer 125 can verify whether operation of the capture unit 101, the pre-processor 105, the scaler 110, and the post-processor 115 were correctly performed.

In a conventional DTV, the number of data buses accessing the frame buffer 125 is minimized to reduce a delay in signal processing that may be caused by an increase in bandwidth. An image device is therefore configured to process images input from broadcast stations or other external devices while minimizing delay. Accordingly, in the conventional DTV, only elements needed for an intermediate procedure, i.e., the capture unit 101, the pre-processor 105, the scaler 110, and the post-processor 115 are connected to the frame buffer 125. A final output terminal, i.e., the encoder 120 is not connected with the frame buffer 125 and the final output signal F_OUT is directly output from the encoder 120 without being verified.

In order to verify the final output signal F_OUT output from the encoder 120, the output capture and test unit 130 and the data bus 155 are additionally required. This requires an additional right of access, which causes a delay and an error in signal processing due to the increase in bandwidth, as described above. Verifying the final output signal F_OUT in real time increases processing overhead.

In addition, in conventional PIP systems in which a main picture and a sub-picture are simultaneously displayed on a single screen, a sub-picture generator (not shown) is additionally required. The main picture is generated by the pre-processor 105 and the post-processor 115. In this case, the picture quality of a signal is improved and an image is displayed at high definition.

However, the sub-picture generator does not include the pre-processor 105 or the post-processor 115, which are for improving the picture quality. A signal output as a sub-picture is not processed for noise reduction and improvement of the picture quality. Rather, the sub-picture is only size-adjusted and encoded. Accordingly, when the sub-picture is displayed on a large screen, the quality of the sub-picture is decreased. Therefore, conventional image processing systems cannot provide high-definition sub-pictures.

A block for generating a simple pattern is provided to perform verification in order to test the effectiveness of a capture in the conventional image processing systems (e.g., DTV). However, it is difficult to verify images input from various sources (e.g., DVDs and game software) and other video images due to hardware limitations.

### SUMMARY OF THE INVENTION

Exemplary embodiments of the present, invention provide an image processing system and method for providing a high-definition sub-picture.

Exemplary embodiments of the present invention also provides an image processing system and method for verifying the picture quality of a final output signal and the correctness of a capture while minimizing the need for additional processing elements and data buses.

According to an exemplary embodiment of the present invention, an image processing system includes a capture unit, a main route unit, a sub-route unit, and a frame buffer. The capture unit captures an image frame signal and outputs a first main frame signal and a first sub-frame signal. The main route unit receives the first main frame signal, adjusts a size and picture quality of the first main frame signal for a main picture of a display device, and outputs a first final output signal. The sub-route unit receives the first sub-frame signal, adjusts a size and picture quality of the first sub-frame signal for a sub-picture of the display device, and outputs a second final output signal. The frame buffer is connected to the capture unit, the main route unit, and the sub-route unit through data buses, respectively. Frame signals output from the capture unit, the main route unit, and the sub-route unit are stored. The capture unit is connected with an output terminal of the main route unit via a feedback route.

According to another exemplary embodiment of the present invention, an image processing method includes generating a main picture by capturing a first image frame signal. Size adjustment, picture quality improvement, and encoding are performed on a captured signal. A first final output signal is output to a display device as the main picture. A sub-picture is generated by capturing the first final output signal, adjusting a size of a captured signal to correspond to the size of the sub-picture, encoding a size-adjusted signal, and outputting an encoded signal to the display device as the sub-picture.

According to another exemplary embodiment of the present invention, an image processing method includes generating a main picture by capturing a first image frame signal. Size adjustment, picture quality improvement and encoding are performed on a captured signal. A first final output signal is output to a display device as the main picture. The first final output signal is received as a second image frame signal. The second image frame signal is captured. The captured second image frame signal is stored in a frame buffer as a stored capture signal. The picture quality of the first final output signal is tested using the stored capture signal.

### BRIEF DESCRIPTION OF THE DRAWINGS

The above and other features of the present disclosure will become more apparent by describing in detail exemplary embodiments of the present invention with reference to the attached drawings in which:

FIG. 1A illustrates frame signals input into an image processing system;

FIG. 1B illustrates a conventional image processing system;

FIG. 2 illustrates an image processing system according to an exemplary embodiment of the present invention;

FIG. 3 illustrates an image processing method for providing a high-definition sub-picture according to an exemplary embodiment of the present invention;

FIG. 4 is a flowchart of the image processing method illustrated in FIG. 3;

FIG. 5 illustrates an image processing method for verifying the picture quality of a final output signal according to an exemplary embodiment of the present invention;

FIG. 6 is a flowchart of the image processing method illustrated in FIG. 5; and

FIG. 7 illustrates an image processing method for verifying a capture according to an exemplary embodiment of the present invention.

### DETAILED DESCRIPTION OF THE INVENTION

Exemplary embodiments of the present invention will be described in detail with reference to the attached drawings. Like reference numerals in the drawings may denote like elements.

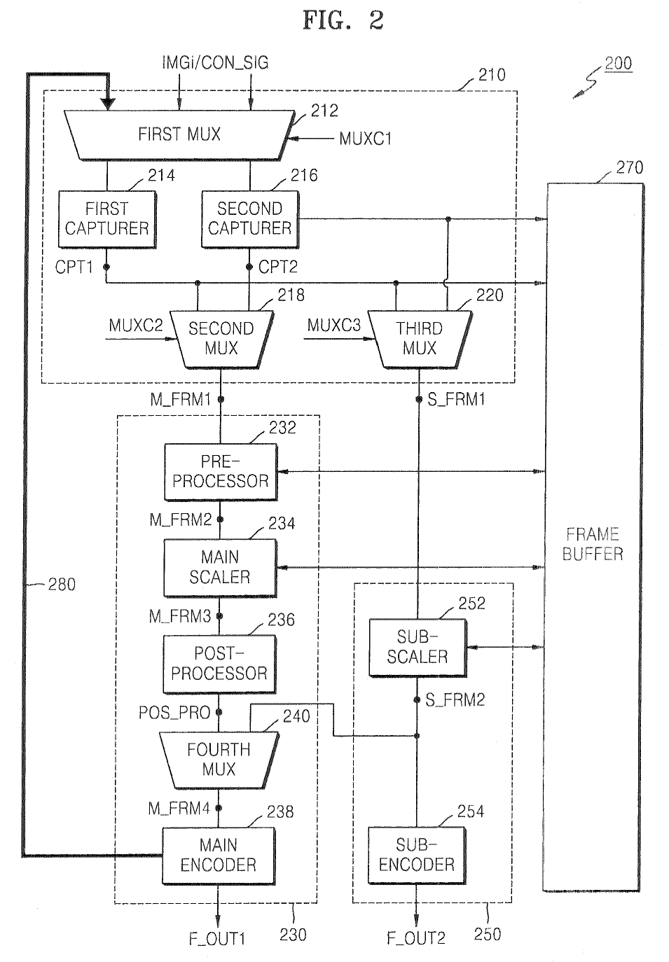

FIG. 2 illustrates an image processing system 200 according to an exemplary embodiment of the present invention. Referring to FIG. 2, the image processing system 200 includes a capture unit 210, a main route unit 230, a sub-route unit 250, and a frame buffer 270.

The capture unit 210 captures an input image frame signal IMGi and outputs a first main frame signal M_FRM1 and a first sub-frame signal S_FRM1 to the main route unit 230 and the sub-route unit 250, respectively. A control signal CON_SIG is input into the capture unit 210 together with the image frame signal IMGi. A user may input various control signals, for example, signals generating various sync signals and multiplexer (MUX) control signals.

The capture unit 210 includes a first MUX 212, a first capturer 214, a second capturer 216, a second MUX 218, and a third MUX 220. The first MUX 212 selectively outputs the image frame signal IMGi to either the first capturer 214 or the second capturer 216 in response to a first MUX control signal MUXC1 input by a user. When the first capturer 214 is selected, the image frame signal IMGi is captured by the first capturer 214 and is output as a first, capture signal CPT1.

The first capturer 214 and the second capturer 216 capture the image frame signal IMGi and output first and second capture signals CPT1 and CPT2, respectively, to the second MUX 218, the third MUX 220, and the frame buffer 270. The first and second capturers 214 and 216 are for capturing the image frame signal IMGi and are used regardless of output of a main picture. When the first capturer 214 is not used, the image frame signal IMGi may be input into the first capturer 214 and captured by the first capturer 214.

The second MUX 218 selectively outputs either the first capture signal CPT1 or the second capture signal CPT2 as the first main frame signal M_FRM1 in response to a second MUX control signal MUXC2 input by a user. The first main frame signal M_FRM1 generates a main picture.

The third MUX 220 selectively outputs either the first capture signal CPT1 or the second capture signal CPT2 as the first sub-frame signal S_FRM1 in response to a third MUX control signal MUXC3 input by a user. The first sub-frame signal S_FRM1 generates a sub-picture.

Accordingly, when a user intends to display a main picture, the second MUX 218 is activated. The second MUX 218 selects and outputs either the first capture signal CPT1 or the second capture signal CPT2 to the main route unit 230. The third MUX 220 is not activated.

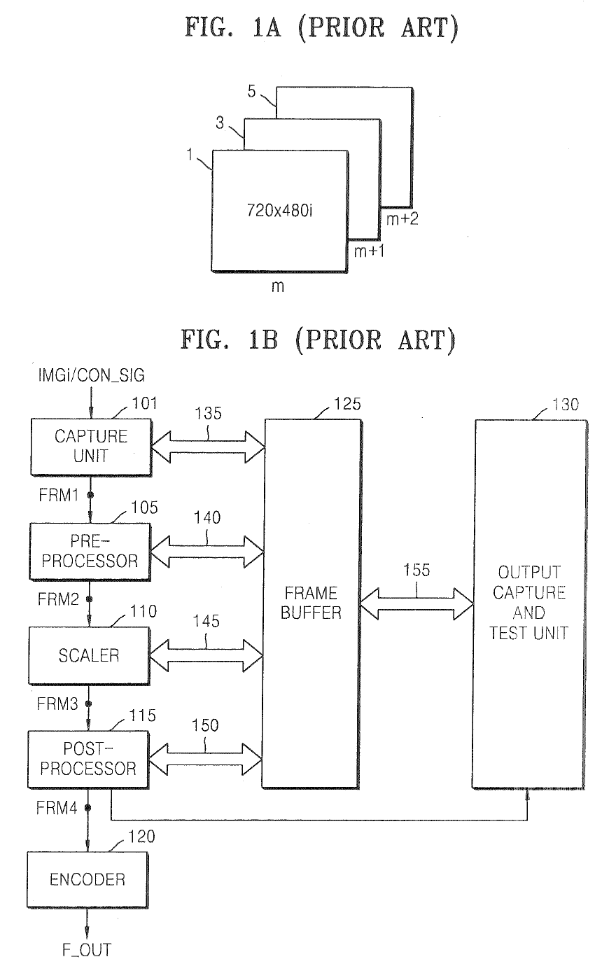

The main route unit 230 includes a pre-processor 232, a main scaler 234, a post-processor 236, and a main encoder 238. The main route unit 230 performs signal processing such as noise reduction and picture quality improvement on a captured image frame signal and outputs a first final output signal F_OUT1 for generating a main picture on a display device. The detailed description of the pre-processor 232, the main scaler 234, the post-processor 236, and the main encoder 238 are similar to the pre-processor 105, the scaler 110, the post-processor 115, and the encoder 120 illustrated in FIG. 1B and described above.

The pre-processor 232 receives the first main frame signal M_FRM1 and removes noise therefrom and outputs a second main frame signal M_FRM2.

The main scaler 234 adjusts the size of the second main frame signal M_FRM2 to correspond to the size of a main picture and outputs a third main frame signal M_FRM3.

The post-processor 236 improves the picture quality of the third main frame signal M_FRM3 and outputs a fourth main frame signal M_FRM4. The main route unit 230 can further comprise a fourth MUX 240. The fourth MUX 240 selectively outputs either a second sub-frame signal S_FRM2 output from the sub-route unit 250 or a post-processed signal POS_PRO output from the post-processor 236.

The main encoder 238 encodes the fourth main frame signal M_FRM4 and outputs the first final output signal F_OUT1 to a display device as a main picture. The display device may be an output device such as a digital TV receiver or a monitor.

The sub-route unit 250 adjusts the size of a captured image frame signal and encodes the size adjusted image frame signal in order to output a second final output signal F_OUT2 for generating a sub-picture on a display device. The sub-route unit 250 includes a sub-sealer 252 and a sub-encoder 254. The sub-route unit 250 need not include the pre-processor 232 and the post-processor 236. When the sub-route unit 250 includes the pre-processor 232 and the post-processor 236, a high-definition sub-picture can be obtained without using a feedback route, but the cost of manufacturing a system and bandwidth usage are increased. According to the current exemplary embodiment of the present invention, the image processing system 200 includes a feedback route 280 which is used to obtain a high-definition sub-picture.

The sub-scaler 252 adjusts the size of the first sub-frame signal S_FRM1 to correspond to the size of a sub-picture in order to output the second sub-frame signal S_FRM2. The sub-encoder 254 encodes the second sub-frame signal S_FRM2 in order to output the second final output signal F_OUT2.

The frame buffer 270 stores frame signals output from the first and second capturers 214 and 216, the pre-processor 232, the scalers 234 and 252, the post-processor 236, and the encoders 238 and 250.

An output terminal of the main encoder 238 and an input terminal of the capture unit 210 connected with each other via the feedback route 280. Accordingly, the first final output signal F_OUT1 is input into the capture unit 210 as the image frame signal IMGi.

The initial image frame signal IMGi is processed by the capture unit 210 and the main route unit 230 and then output as the first final output signal F_OUT1 for generating a high-definition main picture. Here, the initial image frame signal IMGi is referred to as a first image frame signal IMGi_1. The first final output signal F_OUT1 is fed back to the capture unit 210 via the feedback route 280. Here, the first final output signal F_OUT1 is referred to as a second image frame signal IMGi_2.

To select a sub-picture, a user inputs the control signal CON_SIG to activate the third MUX 220 and deactivate the second MUX 218. Accordingly, the second image frame signal IMGi_2, after being captured, is input into the sub-route unit 250 and is adjusted to a size of the sub-picture and encoded by the sub-route unit 250. The sub-route unit 250 outputs the second final output signal F_OUT2 for generating a high-definition sub-picture. As described above, since the first final output signal F_OUT1 having high definition is used as an input via the feedback route 280 when a sub-picture is generated, a high-definition sub-picture can be provided without using additional pre- and post-processors and a data bus.

Unlike the conventional image processing system which outputs a final output signal generated by an encoder without verification, the image processing system 200 according to the current exemplary embodiment of the present invention enables the first final output signal F_OUT1 to be captured by the capture unit 210 by using the feedback route 280. The first final output signal F_OUT1 is stored in the frame buffer 270 after being captured. Accordingly, a user can verify the picture quality of a final output signal using the first final output signal F_OUT1 stored in the frame buffer 270.

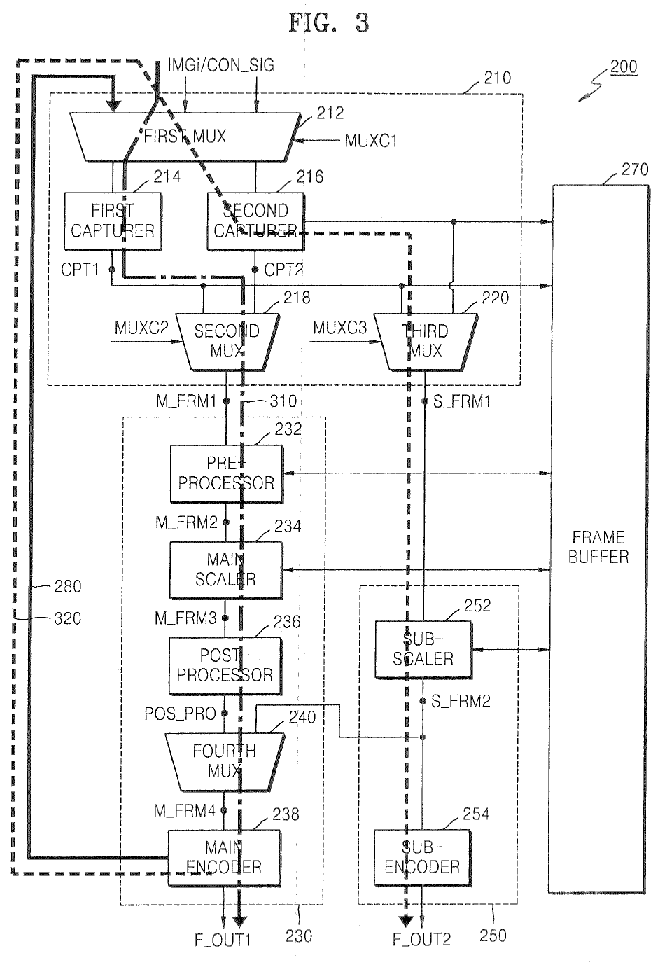

FIG. 3 illustrates an image processing method for providing a high-definition sub-picture according to an exemplary embodiment of the present invention. The image processing system 200 outputs the first final output signal F_OUT1 for generating a high-definition main picture through a first loop 310. The first image frame signal IMGi_1 is captured by the first or second capturer 214 or 216 and then output through the second MUX 218. Thereafter, the image frame signal is processed by the main route unit 230 and is output as the first final output signal F_OUT1.

In a second loop 320, the first final output signal F_OUT1 is input into the capture unit 210 as the second image frame signal IMGi_2. The second image frame signal IMGi_2 is captured and then output through the third MUX 220. The second image frame signal is adjusted to the size of a sub-picture, then encoded, and then output as the second final output signal F_OUT2 for generating a sub-picture. The sub-picture is obtained by processing the first final output signal F_OUT1 having high definition and is thus a high definition signal.

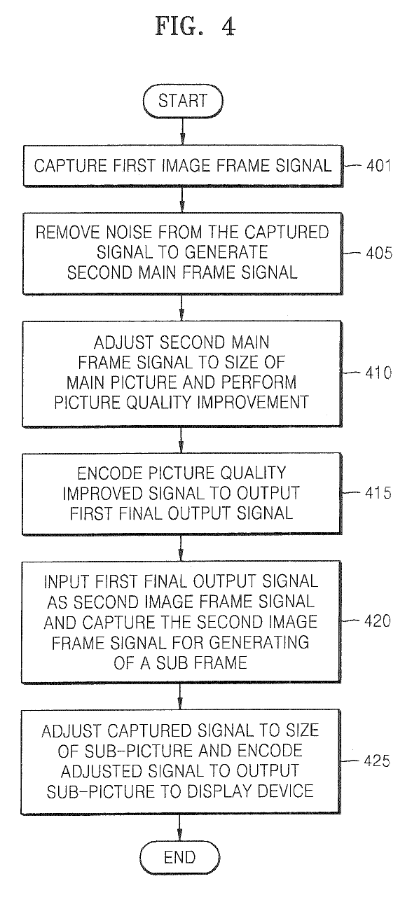

FIG. 4 is a flowchart of the image processing method illustrated in FIG. 3. The first image frame signal IMGi_1 is captured (Step 401). Noise is removed from a captured signal and the second main frame signal M_FRM2 is generated (Step 405).

The second main frame signal M_FRM2 is adjusted to a size of a main picture and is subjected to picture quality improvement. The third main frame signal M_FRM3 is thereby generated (Step 410). The third main frame signal M_FRM3 is encoded and the first final output signal F_OUT1 is output (Step 415).

The first final output signal F_OUT1 is input as the second image frame signal IMGi_2 (Step 420). The second image frame signal is captured and the generation of a sub-picture is based on the captured second image frame signal. An output terminal of the first final output signal F_OUT1 is connected to an input terminal for generating a sub-picture through a feedback route. The input terminal for generating a sub-picture is a terminal receiving the second image frame signal IMGi_2 and corresponds to an input terminal of the capture unit 210 included in the image processing system 200.

The first sub-frame signal S_FRM1 corresponding to a result of capturing the second image frame signal IMGi_2 is adjusted to the size of a sub-picture and then encoded in order to output the second final output signal F_OUT2 for generating the sub-picture to a display device (Step 425).

Accordingly, an output of the main encoder 238, which generates a signal for generating a main picture, is connected with the capture unit 210 and outputs a high-definition sub-picture.

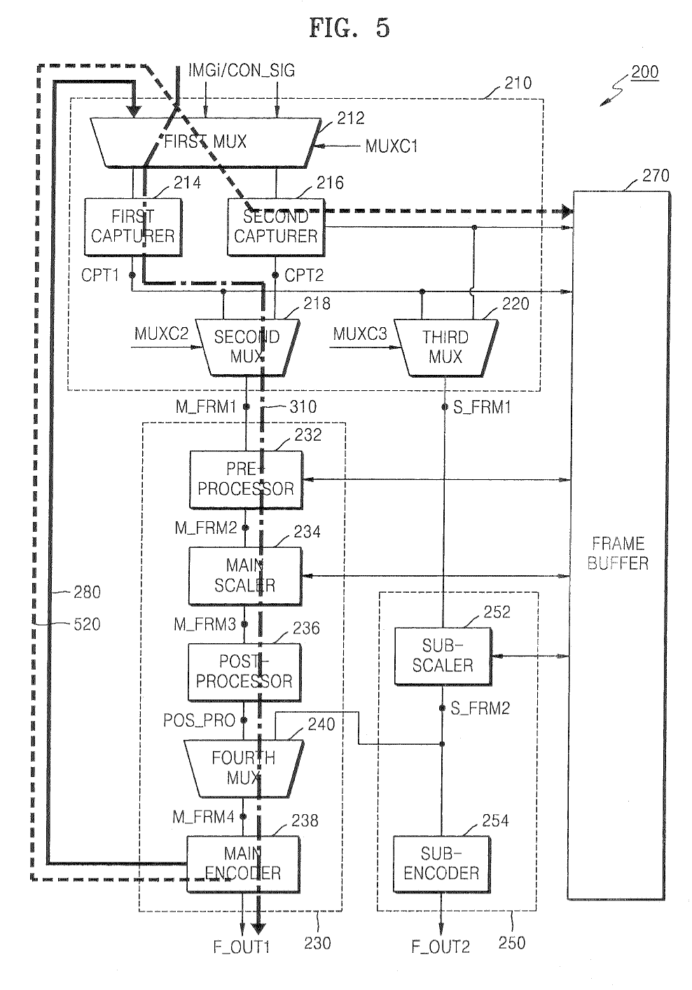

FIG. 5 illustrates an image processing method for verifying the picture quality of a final output signal according to an exemplary embodiment of the present invention. The image processing system 200 outputs the first final output signal F_OUT1 for generating a main picture through the first loop 310. The first image frame signal IMGi_1 is captured by the first or second capturer 214 or 216 and then output through the second MUX 218. Thereafter, the image frame signal is processed by the main route unit 230 and is output as the first final output signal F_OUT1.

In a third loop 520, the first final output signal F_OUT1 is input into the capture unit 210 as the second image frame signal IMGi_2 through the feedback route 280. The second image frame signal IMGi_2 is captured by the first or second capturer 214 or 216 and is then stored in the frame buffer 270. The captured signals stored in the frame buffer 270 are referred to as stored capture signals CPT2_1 and CPT2_2. Capturing may be performed by either the first or second capturers 214 and 216. The capture unit 210 verifies if the capturing is performed correctly using the stored capture signals CPT2_1 and CPT2_2.

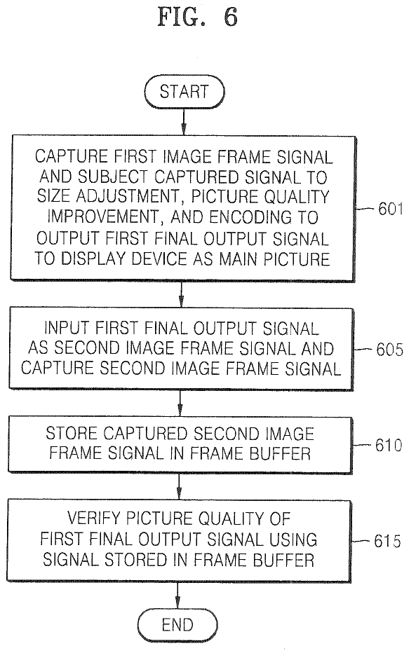

FIG. 6 is a flowchart of the image processing method illustrated in FIG. 5. The first image frame signal IMGi_1 is captured and the captured signal is subjected to size adjustment, picture quality improvement, and encoding. The first final output signal F_OUT1 is output to a display device as a main picture (Step 601). The first final output signal F_OUT1 is input as the second image frame signal IMGi_2 and captured (Step 605). The captured signals are stored in the frame buffer 270 as the stored capture signals CPT2_1 and CPT2_2 (Step 610). The stored capture signals CPT2_1 and CPT2_2 are called and used to verify the picture quality of the first final output signal F_OUT1 (Step 615).

In the conventional image processing system illustrated in FIG. 1B, the final output signal F_OUT output from the encoder 120 is directly output without being stored in the frame buffer 125 and verified. To verify the final output signal F_OUT, an additional element and the right of access to a data bus are used. However, in some exemplary embodiments of the present invention, a final output signal is input into an input terminal of the capture unit 210 through the feedback route 280 and the final output signal can be verified without requiring additional elements.

When the first final output signal F_OUT1 is verified, whether the first final output signal F_OUT1 has the desired picture quality for a main picture and whether an output time and caption are correct may be verified. When the picture quality is verified, it is verified whether the picture quality has deteriorated during encoding. When the output time is verified, it is verified whether a displayed picture has suddenly stopped and output is discontinuous. Verification of captioning is used for an English caption or a real-time caption broadcast for hearing-impaired people. The caption is added to an image frame signal output from the post-processor 236 and the image frame signal with the caption is encoded. It is verified whether the caption is correctly displayed on a screen with the encoded image frame signal.

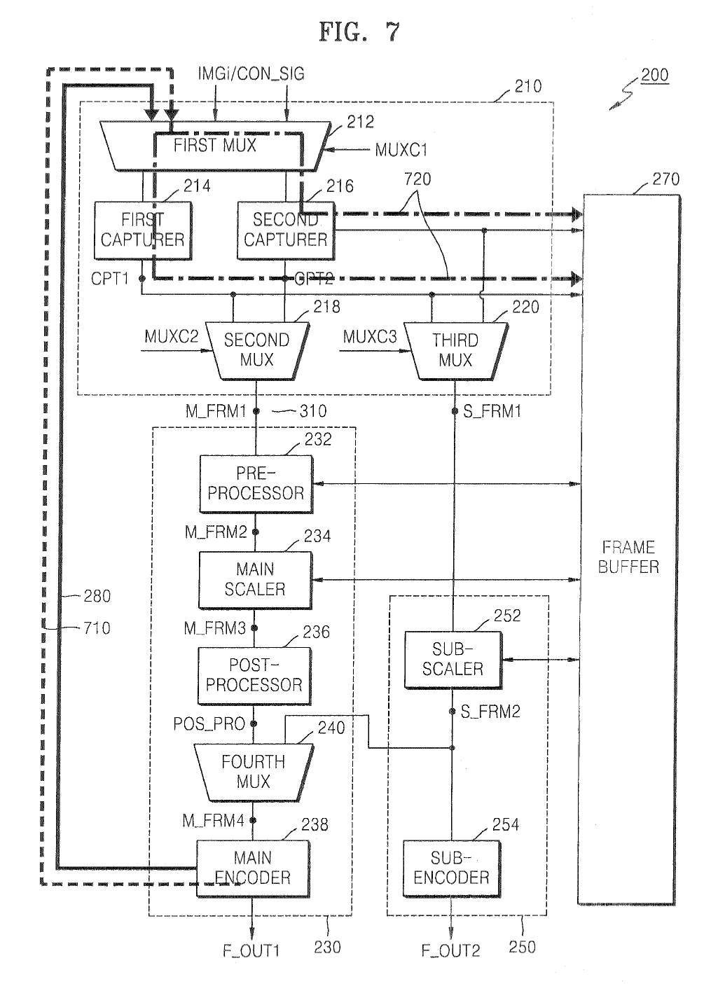

FIG. 7 illustrates an image processing method for verifying a capture according to an exemplary embodiment of the present invention. Referring to FIG. 7, a final output signal is output through a fourth loop 710, and is input into the capture unit 210 through the feedback route 280. The feedback signal is captured and stored through a fifth loop 720. The outputting of the final output signal, the capturing, and the storing are performed similarly to steps 601, 605, and 610 illustrated in FIG. 6.

Thereafter, a stored capture signal and a capture signal obtained by capturing the first image frame signal are called to verify whether the capture unit 210 has operated properly.

The first image frame signal IMGi_1 may be of various kinds. An image having a complicated pattern or a motion may be input. When the first image frame signal IMGi_1 having a motion image is processed, the first final output signal F_OUT1 also has a motion image. Accordingly, when the first final output signal F_OUT1 having a motion image is fed back to the capture unit 210, the correctness of a capture of the motion image can be verified.

As described above, according to exemplary embodiments of the present invention, a main route for generating a main picture is separated from a sub-route for generating a sub-picture and a final output signal is fed back to a capture unit. A high-definition sub-picture is thereby obtained. In addition, the picture quality of the final output signal and the effectiveness of a capture can be verified without using additional elements.

While exemplary embodiments of the present invention have been particularly shown and described with reference to the figures, it will be understood by those of ordinary skill in the art that various changes in form and details may be made therein without departing from the spirit and scope of the present invention.

What is claimed is:

1. An image processing system comprising:
a capture unit capturing an image frame signal and outputting a first main frame signal and a first sub-frame signal;
a main route unit receiving the first main frame signal, adjusting size and picture characteristics of the first main frame signal for a main picture of a display device, and outputting a first final output signal;
a sub-route unit, receiving the first sub-frame signal, adjusting size and picture characteristics of the first sub-frame signal for a sub-picture of the display device, and outputting a second final output signal; and
a frame buffer connected to the capture unit, the main route unit, and the sub-route unit through at least one data bus, and storing frame signals output from the capture unit, the main route unit, and the sub-route unit,
wherein the capture unit is connected to an output terminal of the main route unit via a feedback route.

2. The image processing system of claim 1, wherein the feedback route enables the first final output signal to be fed back to an input terminal of the capture unit as another image frame signal.

3. The image processing system of claim 2, wherein the sub-route unit comprises:
a sub-sealer adjusting the size of the first sub-frame signal to correspond to the size of the sub-picture of the display device and outputting a second sub-frame signal; and
a sub-encoder encoding the second sub-frame signal and outputting the second final output signal.

4. The image processing system of claim 2, wherein the first sub-frame signal is a high-definition signal obtained by capturing the first final output signal.

5. The image processing system of claim 4, wherein the sub-route unit outputs the high-definition first sub-frame signal as the sub-picture of the display device.

6. The image processing system of claim 3, wherein the main route unit comprises:
a pre-processor removing noise from the first main frame signal and outputting a second main frame signal;
a main scaler adjusting the size of the second main frame signal to correspond to the size of the main picture of the display device and outputting a third main frame signal;
a post-processing block adjusting picture characteristics on the third main frame signal and outputting a fourth main frame signal; and
a main encoder encoding the fourth main frame signal and outputting the first final output signal as the main picture of the display device.

7. The image processing system of claim 1, wherein the capture unit comprises:
a first multiplexer outputting the image frame signal to a first capturer or a second capturer in response to a first multiplexer control signal;
a first capturer capturing the image frame signal and outputting a first capture signal;
a second capturer capturing the image frame signal and outputting a second capture signal;
a second multiplexer selectively outputting the first or second capture signal as the first main frame signal, as the main picture, in response to a second multiplexer control signal; and
a third multiplexer selectively outputting the first or second capture signal as the first sub-frame signal, as the sub-picture, in response to a third multiplexer control signal.

8. The image processing system of claim 7, wherein the first, second and third multiplexer control signals are input by a user.

9. The image processing system of claim 6, wherein the post-processing block comprises:
a post-processor receiving the third main frame signal, adjusting picture characteristics of the third main frame signal, and outputting a post-processed signal; and
a fourth multiplexer receiving the post-processed signal and the second sub-frame signal and selecting and outputting one of the two signals as a fourth main frame signal in response to a control signal input by a user.

10. The image processing system of claim 6, wherein the capture unit, the pre-processor, the main scaler, the sub-sealer, the post-processing block, the main encoder, and the sub-encoder are connected to the frame buffer via respective data buses.

11. An image processing method comprising:
generating a main picture by capturing a first image frame signal, adjusting size and picture characteristics and encoding on the captured signal, outputting a first final output signal to a display device as the main picture; and
generating a sub-picture by capturing the first final output signal, adjusting a size of the captured signal to correspond to the size of the sub-picture, encoding a size-adjusted signal, and outputting an encoded signal to the display device as the sub-picture.

12. The image processing method of claim 11, wherein generating the sub-picture comprises:
receiving the first final output signal as a second image frame signal corresponding to an input signal on which the sub-picture generation is based; and
capturing the first final output signal, adjusting the size of the captured signal to correspond to the size of the sub-picture, encoding the size-adjusted signal, and outputting the encoded signal to the display device as the sub-picture.

13. The image processing method of claim 12, wherein the steps of capturing, adjusting, encoding, and outputting comprise:
capturing the first output signal and outputting a first sub-frame signal;
adjusting the size of the first sub-frame signal to the sub-picture and outputting a second sub-frame signal; and
encoding the second-frame signal and outputting an encoded sub-frame signal to the display device as the sub-picture.

14. The image processing method of claim 11, wherein generating the main picture comprises:
capturing the first image frame signal and outputting a first main frame signal;
removing noise from the first main frame signal and outputting a second main frame signal; and
adjusting the size of the second main frame signal to correspond to the size of the main picture and outputting a third main frame signal.

15. The image processing method of claim 14, wherein generating the main picture further comprises:
adjusting picture characteristics of the third main frame signal and outputting a fourth main frame signal; and
encoding the fourth main frame signal and outputting the first final output signal.

16. An image processing method comprising:
generating a main picture by capturing a first image frame signal, adjusting size and picture characteristics and encoding on the captured signal, outputting a first final output signal to a display device as the main picture;
receiving the first final output signal as a second image frame signal and capturing the second image frame signal; and
storing the captured second image frame signal in a frame buffer as a stored capture signal.

17. The image processing method of claim 16, further comprising testing a picture quality of the first final output signal by comparing the first final output signal to the stored capture signal.

18. The image processing method of claim 16, wherein the first final output signal comprises a final frame signal corresponding to an image signal output as the main picture, output time information on the first final output signal, and control signals used to generate the final frame signal.

19. The image processing method of claim 18, further comprising verifying a real-time caption for the first final output signal.

20. The image processing method of claim 18, wherein the verifying comprises verifying output time of an encoder outputting the first final output signal using the output time information on the first final output signal.

21. The image processing method of claim 16, further comprising verifying a capture using the stored capture signal.

22. The image processing method of claim 21, wherein the first image frame signal corresponds to an image having a complicated pattern or a motion, and
wherein verifying the capture comprises verifying a capture of the first final output signal including the image having the complicated pattern or the motion.
